(19) United States
(12) Patent Application Publication
(10) Pub. No.: US 2024/0296108 A1
(43) Pub. Date: Sep. 5, 2024

(54) Apparatus, Device, Method and Computer Program for Generating Test Cases for Verification of Hardware Instructions of a Hardware Device in Hypervisor

(71) Applicant: Intel Corporation, Santa Clara, CA (US)

(72) Inventors: Qian OUYANG, Shanghai (CN); Junjie MAO, Shanghai (CN); Yi QIAN, Shanghai (CN); Minggui CAO, Shanghai (CN); Jian Jun CHEN, Shanghai (CN); Junjun SHAN, Shanghai (CN); Xiangyang WU, Shanghai, CA (US)

(21) Appl. No.: 18/572,211

(22) PCT Filed: Oct. 14, 2021
(86) PCT No.: PCT/CN2021/123931

§ 371 Date: Dec. 20, 2023

(51) Int. Cl. G06F 11/36

(52) U.S. Cl. CPC G06F 11/3684

(57) ABSTRACT

It relates to an apparatus, a device, a method, and a computer program for generating test cases for a verification of hardware instructions of a hardware device in a hypervisor. The apparatus comprises circuitry configured to generate a transition table based on a specification of the hardware device. The transition table comprises a plurality of entries. Each entry represents a change of a state of the hardware device in response to an event. The circuitry is configured to determine entries of the transition table that are equivalent. The circuitry is configured to generate a plurality of test cases based on the entries of the transition table. At least one entry of the transition table is omitted in the generation of the test cases due to being equivalent to another entry of the transition table.

### BACKGROUND

Hypervisor stacks, such as ACRN (an open-source hypervisor), provide a virtual environment that behaves like real hardware. It is therefore important to make sure the hypervisor behaves correctly according to CPU (Central Processing Unit) specification and security requirements. However, as there are more thousands of CPU instructions in SDM (Software Development Manual), more than ten thousand test cases might be considered to cover their different conditions and exceptions, which is a considerable workload for the developers of such a hypervisor. For example, on native platforms (that access the CPU without going through a hypervisor), more than 10 000 may be used to cover all CPU instructions. For example, so far, open-source hypervisors might not provide such a full scope of tests. Instead, the full scope of tests might only be performed on the native platform, which might not be useable for testing the hypervisor.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for generating test cases for a verification of hardware instructions of a hardware device in a hypervisor;

FIG. 1b shows a flow chart of an example of a method for generating test cases for a verification of hardware instructions of a hardware device in a hypervisor;

FIG. 2 shows an example of a transition table;

FIG. 3 shows an example of three entries that are considered to be identical;

FIG. 4 shows an example of two entries that are not considered to be identical; and

FIG. 5 shows an example of a workflow for selecting instructions to be tested.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/example,” “some embodiments/example,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/example,” “in some embodiments/examples,” and/or “in various embodiments/examples,” each of which may refer to one or more of the same or different embodiments or examples. Furthermore, the terms “comprising,” “including,” “having,” and the like, as used with respect to embodiments of the present disclosure, are synonymous.

Various examples of the present disclosure relate to a concept for automatic test case creation for the verification of instructions of a hardware device, such as CPU instructions, in a hypervisor. For example, the proposed concept may provide a concept to test the CPU instruction upon a virtual machine by selecting a small subset of test cases while still achieving sufficient coverage.

The proposed concept is based on two insights. First, most of the instructions running being executed in a VM are under a hypervisor pass-through mode, so the critical path of the CPU instruction verification in the VM may be seen in the exception handling. Second, the number of exceptions is limited. Based on these two insights, the proposed concept may introduce a way to select a small set of test cases to cover the CPU instruction handling paths and conditions in the hypervisor, which may save 80% test effort. For example, compared to 10,000 test cases, the proposed concept may result in 2000 test cases to cover the same scope, i.e., reducing the test effort by 80%. For example, in open source hypervisors, such as ACRN, when users port the implementation into their platform, with this proposed concept, the users can reduce their test workload. For example, the proposed concept may help reduce the effort required for enabling new platforms by providing this reduced test workload.

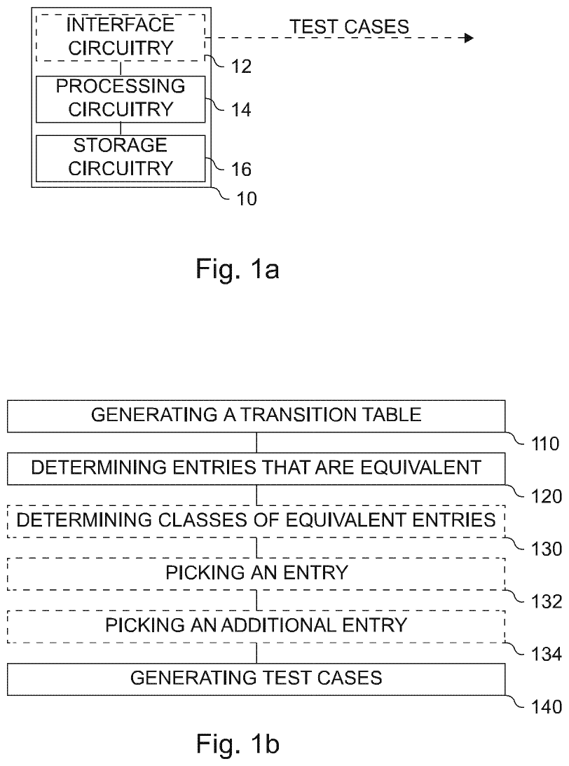

FIG. 1a shows a block diagram of an example of an apparatus 10 or device 10 for generating test cases for a verification of hardware instructions of a hardware device in a hypervisor. The apparatus 10 comprises circuitry that is configured to provide the functionality of the apparatus 10. For example, the apparatus 10 may comprise interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., for obtaining a specification of the hardware device and/or for providing the test cases) and the storage circuitry (for storing information) 16. Likewise, the device may comprise means that is/are configured to provide the functionality of the device 10. The components of the device 10 are defined as component means, which may correspond to, or implemented by, the respective structural components of the apparatus 10. For example, the device 10 may comprise means for processing 14, which may correspond to or be implemented by the processing circuitry 14, means for communicating 12, which may correspond to or be implemented by the interface circuitry 12, and means for storing information 16, which may correspond to or be implemented by the storage circuitry 16.

The circuitry or means is configured to generate a transition table based on a specification of the hardware device, the transition table comprising a plurality of entries. Each entry represents a change of a state of the hardware device in response to an event. The circuitry or means is configured to determine entries of the transition table that are equivalent. The circuitry or means is configured to generate a plurality of test cases based on the entries of the transition table. At least one entry of the transition table is omitted in the generation of the test cases due to being equivalent to another entry of the transition table.

FIG. 1b shows a flow chart of an example of a corresponding method for generating the test cases for the verification of the hardware instructions of the hardware device in a hypervisor. The method comprises generating 110 the transition table based on the specification of the hardware device. The transition table comprises the plurality of entries. Each entry represents a change of the state of the hardware device in response to an event. The method comprises determining 120 the entries of the transition table that are equivalent. The method comprises generating 140 the plurality of test cases based on the entries of the transition table. At least one entry of the transition table is omitted in the generation of the test cases due to being equivalent to another entry of the transition table.

In the following, the functionality of the apparatus 10, the device 10, the method and of a corresponding computer program is introduced in connection with the apparatus 10. Features introduced in connection with the apparatus 10 may be likewise included in the corresponding device 10, method and computer program.

Various examples of the present disclosure relate to a concept for generating test cases for a verification of hardware instructions of a hardware device in a hypervisor, with the concept being implemented by the above-referenced apparatus, device, method, and a corresponding computer program.

In general, a hypervisor (also denoted “virtual machine manager” VMM) is a computer component that is configured to run (i.e., execute) virtual machines. A hypervisor may be implemented using software, firmware and/or hardware or using a combination thereof. For example, the hypervisor may be a host software, host hardware, host firmware, or a combination thereof. A computer comprising a hypervisor that is used to run one or more virtual machines is usually called a host computer, with the virtual machines being called the guests of the host computer. For example, the hypervisor may be part of a host computer, such as a server computer. For example, the hypervisor may provide access to the hardware device via an abstraction layer. Operations executed on the abstraction layer provided by the hypervisor may be forwarded to the hardware device, with some operations being forwarded in a pass-through mode (where the operations are forwarded to the hardware device unmodified) and some other operations being modified and forwarded. The latter group of operations, i.e., the operations being modified, include in particular operations that relate to exception handling of the hardware device, e.g., when an interrupt occurs due to the instruction being issued. Various examples of the present disclosure relate to the latter group of operations, as the former group of operations need not be modified by the hypervisor.

A hypervisor may virtualize access to the hardware device for one or more guest virtual machines. In particular, the hypervisor may access to a central processing unit of a computer. Accordingly, the hardware device may be a central processing unit and the hardware instructions may be central processing unit instructions. However, access to other types of hardware devices may be virtualized as well. For example, the hardware device may be one of a graphics processing unit, an accelerator card, and an input/output device, such as a network interface card.

The proposed concept relates to the verification of hardware instruction of a hardware device in a hypervisor, i.e., to the verification, whether a handling of the hardware instructions of accessing the hardware device are implemented correctly in the hypervisor. In other words, the verification relates to the handling of the hardware instructions by the hypervisor, which provides a layer of abstraction between a guest virtual machine issuing the hardware instructions and the hardware device being controlled based on the hardware instructions. The hardware instructions are handled by the hypervisor (i.e., forwarded between the virtual machine and the hardware device and vice versa), with some of the instructions being forwarded in pass-through mode and with some of the instructions being modified by the hypervisor. In general, the implementation of the hypervisor might have little impact on the hardware instructions that are forwarded between the virtual machine and the hardware device in pass-through mode. Therefore, these hardware instructions might not be verified by the proposed concept. For example, the proposed concept may be focused on hardware instructions that are not passed-through, but that might require modification by the hypervisor, e.g., for exception handling. In other words, the test cases may relate to hardware instructions that can, in some scenarios, require exception handling by the hypervisor. In other words, each of the hardware instructions may be related to an exception or an external interrupt.

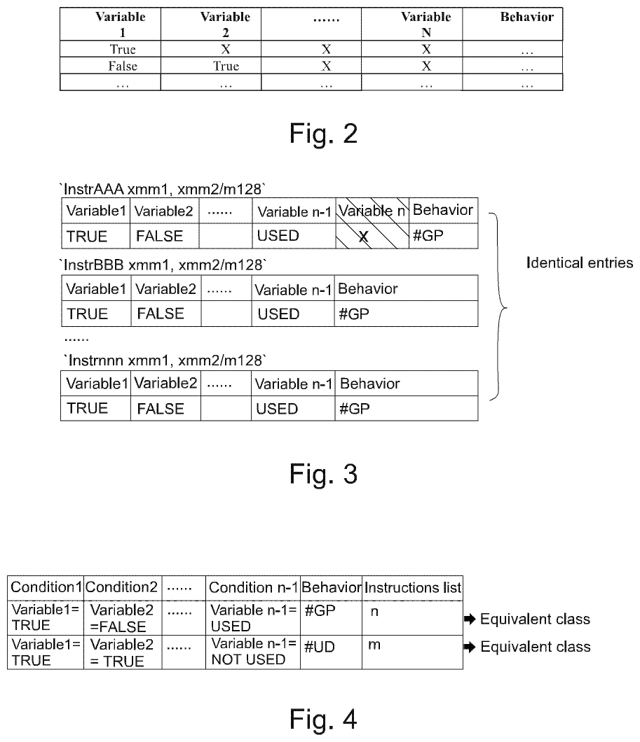

The proposed concept is based on the concept of a “transition table”. Such a transition table comprises a plurality of entries, with each entry comprising two portions-a condition portion, and a behavior portion. An example for this is shown in FIG. 2, where the first four columns are part of the condition portion and the fifth column constitutes the behavior portion. For example, the one or more conditions specified by the condition portion must be met to cause the behavior specified by the behavior portion. Both the one or more conditions and the behavior may be taken from the specification of the hardware device.

In the present concept, the transition table is generated based on the specification of the hardware device. For example, the specification of the hardware device may comprise a formal specification of the hardware instructions of the hardware device. For example, for each hardware instruction of the hardware device, the specification may comprise one or more entries defining the expected behavior of the hardware device and the one or more conditions to be met for triggering the expected behavior. As is evident, at least some of the hardware instructions may have multiple entries in both the specification and the transition table, with each entry for the respective hardware instruction comprising one or more conditions and an associated behavior. In other words, the transition table may be generated based on a plurality of hardware instructions defined in the specification of the hardware device. The entries in the transition table may be based on the plurality of hardware instructions. For example, each hardware instruction may be related to one or more entries in the transition table. In some examples, the transition table may comprise one or more entries that are not (directly) related to a hardware instruction, e.g., one or more instructions that are based on one of an external interrupt and an exception.

These entries of the specification may be translated and used to generate the translation table. In other words, the circuitry is configured to generate the transition table based on the specification of the hardware device, e.g., based on the specification of the plurality of hardware instructions. Additionally, the circuitry may be configured to generate the transition table based on the specification of one of an external interrupt and an exception defined in the specification of the hardware device. For example, the circuitry may be configured to translate the entries of the specification of the hardware device into the entries of the transition table.

As outlined earlier, each entry of the transition table comprises two portions-a condition portion and a behavior portion. As each entry of the transition table represents a change of the state of the hardware device in response to an event, the change of the state may be defined by the behavior portion, and the event may be the cause for checking the one or more conditions of the behavior portion. For example, as each entry of the transition table is related to a hardware instruction (or an external interrupt or an exception), said hardware instruction (or external interrupt or exception) may be the cause for checking, by the hardware device, the one or more conditions. Accordingly, the event may comprise or correspond to one of an execution of a pre-defined instruction (e.g., as shown in FIGS. 3 and 4), an occurrence of an exception and an occurrence of an external interrupt.

For example, each state change may be linked to one or more conditions. In other words, each entry of the transition table may define one or more conditions to be met for affecting the state change (i.e., the condition portion) and the corresponding change of the state of the hardware device (i.e., the behavior portion). In other words, each state change defined by an entry of the transition table may be based on the one or more conditions, so that the state change is triggered by the event, and (only) occurs if the one or more conditions are met. For example, for the same event, different sets of conditions being met may lead to different state changes of the hardware device.

With respect to the cone or more conditions, a variety of different conditions may be defined. For example, the one or more conditions may be based on one or more variables, with each variable representing one of a register or memory cell, a bit field in a register or memory cell, a relation between two register or memory cells or between bit fields of two registers or memory cells, and a logical combination of two or more relations. In other words, the one or more conditions may relate to one of a content of a register or memory cell, a content of a bit field in a register or memory cell, a relation between two register or memory cells or between bit fields of two registers or memory cells, and a logical combination of two or more relations. With respect to the relation between two register or memory cells or between bit fields of two registers or memory cells, two types of relations may be defined, a first type of relation that yields a value that represents the relation (i.e., equal, greater than or smaller than (i.e., less than)) and a second type of relation that yields a binary value that indicates whether the relation satisfies a condition (e.g., that the first bit field/register/memory cell is equal to (or greater than, or smaller than) the second bit field/register/memory cell). In other words, a value of a variable may be one of a hexadecimal value (for the content of a bit field/memory cell), an indicator representing a relation (i.e., equal, greater than or smaller than) between two bit fields, registers or memory cells, and a binary value. For example, the one or more variables may define the one or more conditions, i.e., the condition mandates that the variable is as defined in the entry of the transition table. However, in some cases, the value of a variable might not be relevant for a state change, i.e., the state change may be affected regardless of the variable. In this case, the respective variable may be set to “X”, which is the “don't care” operator in hardware design (in particular in the design of state machines), and which indicates that said variable may take any value and the condition might still be met.

The event, and the one or more conditions, trigger a state change of the hardware device. For example, the state change may be defined by one or more of a change in a memory cell or register, by an interrupt being raised, and by an exception being triggered.

In the present disclosure, the term “transition table” is used. However, the term table in “transition table” is not necessarily to be taken literally. Other data structures, such as a list, a database, a key-value store etc. may constitute a table with respect to the present concept.

In general, the entries of the transition table may define the tests that are to be performed in the verification of the hypervisor with respect to the hardware device. However, some entries of the transition table may be considered to be identical (i.e., equivalent) for the sake of performing the verification of the hypervisor with respect to the hardware device. For example, if two entries defining the same (or equivalent) conditions lead to the same state change, only one of the entries might be required for ensuring sufficient coverage in the verification of the hypervisor. Accordingly, entries that are equivalent (with respect to conditions and state change, for example) are identified in the transition table. For example, two entries of the transition table may be determined to be equivalent if the one or more conditions and the corresponding change of the state of the hardware are equivalent.

In the most basic implementation, two entries may be considered equivalent if they define the same variables, and therefore conditions, and the same state change. This is shown in FIG. 3 between the second and third (n-th) entry. In some examples, the concept is extended by considering variables that are set to the “don't care” value. For example, as outlined earlier, a condition may define either a value of a variable or that the variable is irrelevant for the entry (i.e., “don't care”). For example, if the same condition/variable is set to be irrelevant in both entries, or of a condition is set to irrelevant in one of the entries and the condition is not defined in the other entry, the two entries may be deemed equivalent. In other words, two entries may be determined to be equivalent if a first of the two entries comprises a condition that defines that a given variable is irrelevant and if a second of the two entries either comprises the condition that defines that the given variable is irrelevant or the second entry lacks a condition that is based on the given variable. This is shown in FIG. 3 between the first and second entry, where the first entry defines the variable n as “X” and the second entry omits variable n entirely.

If multiple entries are considered to be equal, only one of the entries might be considered for the test cases. This may be implemented by creating “equivalent classes” (or “equivalence classes”) from the entries. For example, each entry might belong to a single equivalent class, with each equivalent class comprising one or more entries. In other words, some equivalent classes might comprise only a single entry, while some equivalent classes may comprise multiple entries. As outlined earlier, when the concept was applied to code of an open source hypervisor, an 80% reduction of test cases was reached, which indicates that the equivalent classes contained an average of approximately five entries. The circuitry may be configured to determine the classes of equivalent entries of the transition table, and to pick one entry of each class of equivalent entries for the plurality of test cases. Accordingly, as further shown in FIG. 1b, the method may comprise determining 130 classes of equivalent entries of the transition table and picking 132; 134 one entry of each class of equivalent entries for the plurality of test cases.

In general, the entry may be picked randomly (for each equivalent class). Accordingly, the test cases may be based on one entry of each equivalent class that is randomly picked to represent the equivalent class. However, the test cases may be defined with respect to the hardware instructions. If a hardware instruction is related to multiple entries of the transition table and is therefore defined by multiple sets of conditions and associated state changes, and an entry of the hardware instruction is selected for the test cases, these multiple sets of conditions and associated state changes may be used to cover the multiple aspects of the hardware instruction in the test case. Therefore, if a hardware instruction is verified by the test cases, multiple test cases may be used to test the hardware instruction with respect to the multiple sets of conditions and associated state changes, thereby covering multiple equivalent classes. However, in some cases, it may be desirable to cover additional hardware instructions (although the equivalent class is already covered), e.g., to increase the scope of the verification. Therefore, the circuitry may be configured to, if an entry is picked for a first class of equivalent entries that is related to a hardware instruction that is further related to another entry that is picked for a second class of equivalent entries, pick an additional entry for the first class of equivalent entries. Accordingly, as shown in FIG. 1b, the method may comprise, if an entry is picked 132 for a first class of equivalent entries that is related to a hardware instruction that is further related to another entry that is picked for a second class of equivalent entries, picking 134 an additional entry for the first class of equivalent entries. In other words, if an entry is picked that is related to a given hardware instruction, and the hardware instruction is related to another entry that has previously been picked, another entry may be picked. In other words, since the test cases are based on the hardware instructions, if an entry is picked that relates to a hardware instruction for which a test case has been generated, another entry may be picked that relates to a hardware instruction for which no test case has been generated so far.

The circuitry is configured to generate the plurality of test cases based on the entries of the transition table, with at least one entry of the transition table being omitted in the generation of the test cases due to being equivalent to another entry of the transition table. For example, generating the plurality of test cases may comprise selecting hardware instructions from the plurality of hardware instructions based on the entries of the transition table being picked for the test cases. For example, for each entry of the transition table being picked for the test cases, the related hardware instruction may be picked for the plurality of test cases. For example, the plurality of test cases may be based on the selected hardware instructions.

As outlined above, if an equivalent class comprises multiple entries of the transition table, in many cases, at least one of the entries of the equivalent class might not be picked for the plurality of test cases, with the at least one of the entries being related to at least one hardware instruction. The one or more entries not being picked may be omitted for the purposes of generating the test cases, e.g., they may be discarded. Correspondingly, the hardware instructions related with the omitted entries might not be considered for the plurality of test cases, unless they relate to another entry that is being picked for the test cases. Accordingly, the plurality of test cases may be generated based on the plurality of hardware instructions, with hardware instructions that relate to entries of the transition table being picked for the test cases being used to generate the plurality of test cases. Hardware instructions that are unrelated to any of the entries of the transition table being picked for the test cases may be disregarded.

In some examples, the generated test cases may correspond to a list of hardware instructions that is to be used to write the test cases for verifying the hypervisor. In some examples, however, generating the test cases may comprise generating the code of the test cases. For example, the circuitry may be configured to generate the code of the test cases based on the selected hardware instructions, by generating, for each hardware instruction, code that checks, for one or more entries of the transition table or specification related to the hardware instruction, whether the state change is affected in response to the event if the one or more conditions are fulfilled. For example, the circuitry may be configured to generate for each entry of the transition table or specification related to a selected hardware instruction a test case. The test case may comprise for checking whether the state change is affected in response to the event if the one or more conditions are fulfilled as defined by the entry of the transition table of specification.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus, device, method, and computer program are mentioned in connection with the proposed concept or one or more examples described above or below (e.g. FIGS. 2 to 5). The apparatus, device, method, and computer program may comprise one or more additional optional features corresponding to one or more aspects of the proposed concept or one or more examples described above or below.

As has been outlined before, the proposed concept introduces two concepts, the transition table, which describes the instruction's behavior on the VM, and the equivalent class (or equivalence class), which categorizes (all) identical entries in the transition table to reduce the total test cases number while having sufficient coverage.

The transition table depicts how the (virtual) platform state changes upon a particular event. The event can be an execution of specific instruction, an occurrence of an exception or external interrupt, access to a particular register, etc. It is infeasible to enumerate all possible states explicitly due to the enormous states a virtual platform can be in (hundreds of registers, 32-bit or 64-bit wide each, plus a large range of memory). Instead, a transition table may list several conditions and specifies how platform states are changed when a condition is met.

FIG. 2 shows an example of a transition table. Each line in the table is called a transition table entry. An entry specifies the value each variable takes and the behavior (i.e., state changes) when the current state satisfies all the “variable=value” conditions. The transition table of FIG. 2 has n+1 columns for variables 1 . . . n and the corresponding behavior. For example, in the entry in the first row, variable 1 has the value “TRUE”, variable 2 has the value “X” (“Don't Care”), variable n has the value “X” and a behavior is defined. In the entry in the second row, variable 1 has the value “FALSE”, variable 2 has the value “TRUE”, variable n has the value “X”, and a behavior is defined. For example, a variable can be of a register/memory cell, a bit field in a register/memory cell, two register/memory cell/bit fields, where their relation (e.g., equal, greater than, etc.) matters, a certain relation (e.g. equal, greater than, etc.) between two registers/memory cells or certain bits in registers/memory cells., a logical combination of relations and a value of a variable can have one of the following forms. For example, for registers, memory cells or bit fields, their values may be hexadecimals. For two registers/memory cells/bit fields, their values may be the relation between them (e.g., equal, greater than, smaller than). For a relation between registers, memory cells or bit fields, their values may be “TRUE” or “FALSE”. Any variable may have the value “X”, which means “don't care”, i.e. the value does not matter and can be any possible value.

The proposed concept is based on identifying identical (i.e., equivalent) transition table entries. For example, two entries in the transition tables for instruction execution may be treated to be identical (i.e., deemed/considered identical) when/if, for each variable the entries have in common, the values evaluated in the two entries are the same and the behavior is the same.

FIG. 3 shows an example of three entries that are considered to be identical (i.e., equivalent). In the first entry for instruction “InstrAAA xmm1,xmm2/m128”, variable 1 is “TRUE”, variable 2 is “FALSE”, the variable n−1 is “USED”, variable n is “X” and the behavior is “#GP” (a pre-defined behavior). In the second entry for instruction “InstrBBB xmm1,xmm2/m128”, variable 1 is “TRUE”, variable 2 is “FALSE”, the variable n−1 is “USED” and the behavior is “#GP”. In the n-th entry “Instrnnn xmm1, xmm2/m128”, variable 1 is “TRUE”, variable 2 is “FALSE”, the variable n−1 is “USED and the behavior is “#GP”. As is evident, for entries 2 and n, variable n is not defined. The three entries are considered to be identical/equivalent, as the variables that the entries have in common are equivalent, and variable n, which is not defined for the entries 2 and n is “X” (don't care).

In contrast, FIG. 4 shows an example of two entries that are not considered to be identical, and which therefore define different equivalent classes. The first entry has “variable 1=TRUE” as first condition, “variable 2=FALSE” as second condition, “variable n−1=USED” as n−1 th condition, “#GP” (General Protect exception) as behavior and “n” as instruction list. The second entry has “variable 1=TRUE” as first condition, “variable 2=TRUE” as second condition, “variable n−1=NOT USED” as n−1 th condition, “#UD” (Undefined opcode exception) as behavior and “n” as instructions list.

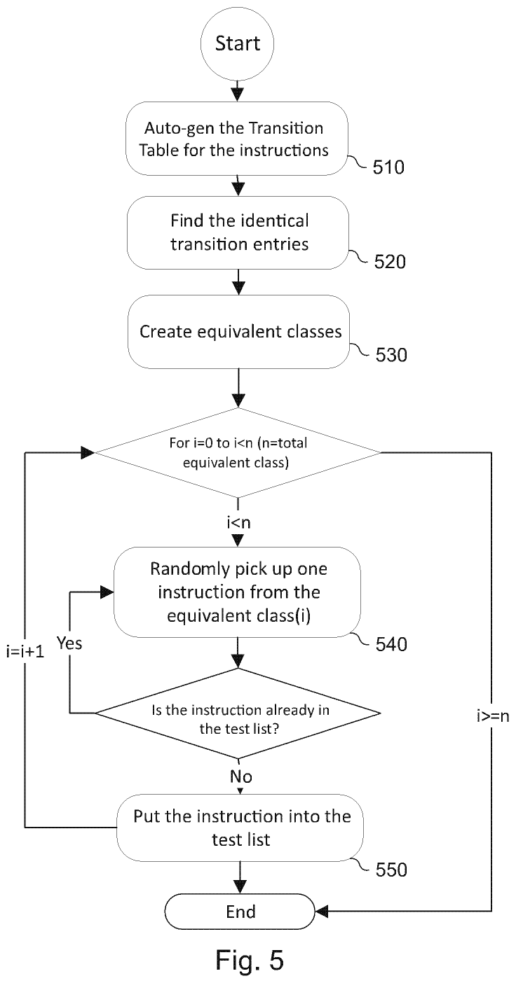

This proposed concept groups identical transition table entries into an equivalent class. In this way, one equivalent class may represent one test scenario. Then one test case may be applied and can cover most of the situations under this equivalent class. The equivalent class may contain a group of instructions that have the same behavior with the same combination of conditions (entry of transition table). For example, the proposed concept may use a random approach to pick up one instruction within one equivalent class. If this instruction is already in the tested list, the algorithm may pick up the next available instruction in this class or group. By the proposed concept, the total test effort may be reduced while still providing sufficient coverage. FIG. 5 shows an example of a workflow for selecting instructions to be tested. In FIG. 5, the workflow starts with automatically generating the transition table for the instructions, e.g., from a specification of the CPU (510). Then, workflow continues with finding the identical entries of the transition table (520). Subsequently, equivalent classes are created (530). Then, the workflow iterates over the created equivalent classes (for i=0 to i<n, with n being the total number of equivalent classes). While i<n, the workflow randomly picks up one instruction from the equivalent class with index i (540). If the instruction is already in the test list, the workflow returns to pick up another instruction from the equivalent class. If not, the instruction is put into the test list (550) and the index i is increased to enter the next iteration of the loop. Once i>=n, the workflow ends.

More details and aspects of the test case generation are mentioned in connection with the proposed concept or one or more examples described above or below (e.g. FIG. 1a to 1b). The test case generation may comprise one or more additional optional features corresponding to one or more aspects of the proposed concept or one or more examples described above or below.

In the following, some examples of the proposed concept are presented:

An example (e.g., example 1) relates to an apparatus (10) for generating test cases for a verification of hardware instructions of a hardware device in a hypervisor, the apparatus comprising circuitry configured to generate a transition table based on a specification of the hardware device, the transition table comprising a plurality of entries, with each entry representing a change of a state of the hardware device in response to an event. The circuitry is configured to determine entries of the transition table that are equivalent. The circuitry is configured to generate a plurality of test cases based on the entries of the transition table, wherein at least one entry of the transition table is omitted in the generation of the test cases due to being equivalent to another entry of the transition table.

Another example (e.g., example 2) relates to a previously described example (e.g., example 1) or to any of the examples described herein, further comprising that the event comprises one of an execution of a pre-defined instruction, an occurrence of an exception and an occurrence of an external interrupt.

Another example (e.g., example 3) relates to a previously described example (e.g., one of the examples 1 to 2) or to any of the examples described herein, further comprising that each entry of the transition table defines one or more conditions to be met for affecting the state change and the corresponding change of the state of the hardware device.

Another example (e.g., example 4) relates to a previously described example (e.g., example 3) or to any of the examples described herein, further comprising that the one or more conditions are based on one or more variables, with each variable representing one of a register or memory cell, a bit field in a register or memory cell, a relation between two register or memory cells or between bit fields of two registers or memory cells, and a logical combination of two or more relations.

Another example (e.g., example 5) relates to a previously described example (e.g., example 4) or to any of the examples described herein, further comprising that a value of a variable is one of a hexadecimal value, an indicator representing a relation between two bit fields, registers or memory cells, and a binary value.

Another example (e.g., example 6) relates to a previously described example (e.g., one of the examples 4 to 5) or to any of the examples described herein, further comprising that a relation is one of equal, greater than or smaller than.

Another example (e.g., example 7) relates to a previously described example (e.g., one of the examples 4 to 6) or to any of the examples described herein, further comprising that wo entries of the transition table are determined to be equivalent if the one or more conditions and the corresponding change of the state of the hardware are equivalent.

Another example (e.g., example 8) relates to a previously described example (e.g., one of the examples 4 to 7) or to any of the examples described herein, further comprising that a condition defines either a value of a variable or that the variable is irrelevant for the entry, wherein two entries are determined to be equivalent if a first of the two entries comprises a condition that defines that a given variable is irrelevant and if a second of the two entries either comprises the condition that defines that the given variable is irrelevant or the second entry lacks a condition that is based on the given variable.

Another example (e.g., example 9) relates to a previously described example (e.g., one of the examples 1 to 8) or to any of the examples described herein, further comprising that the transition table is generated based on a plurality of hardware instructions defined in the specification of the hardware device, wherein the entries in the transition table are based on the plurality of hardware instructions.

Another example (e.g., example 10) relates to a previously described example (e.g., example 9) or to any of the examples described herein, further comprising that each hardware instruction is related to one or more entries in the transition table.

Another example (e.g., example 11) relates to a previously described example (e.g., one of the examples 1 to 10) or to any of the examples described herein, further comprising that the circuitry is configured to determine classes of equivalent entries of the transition table, and to pick one entry of each class of equivalent entries for the plurality of test cases.

Another example (e.g., example 12) relates to a previously described example (e.g., example 11) or to any of the examples described herein, further comprising that the entry is picked randomly.

Another example (e.g., example 13) relates to a previously described example (e.g., one of the examples 11 to 12) or to any of the examples described herein, further comprising that the circuitry is configured to, if an entry is picked for a first class of equivalent entries that is related to a hardware instruction that is further related to another entry that is picked for a second class of equivalent entries, pick an additional entry for the first class of equivalent entries.

Another example (e.g., example 14) relates to a previously described example (e.g., one of the examples 1 to 13) or to any of the examples described herein, further comprising that the hardware device is a central processing unit and the hardware instructions are central processing unit instructions.

An example (e.g., example 15) relates to a device (10) for generating test cases for a verification of hardware instructions of a hardware device in a hypervisor, the device comprising means configured to generate a transition table based on a specification of the hardware device, the transition table comprising a plurality of entries, with each entry representing a change of a state of the hardware device in response to an event. The means is configured to determine entries of the transition table that are equivalent. The means is configured to generate a plurality of test cases based on the entries of the transition table, wherein at least one entry of the transition table is omitted in the generation of the test cases due to being equivalent to another entry of the transition table.

Another example (e.g., example 16) relates to a previously described example (e.g., example 15) or to any of the examples described herein, further comprising that the event comprises one of an execution of a pre-defined instruction, an occurrence of an exception and an occurrence of an external interrupt.

Another example (e.g., example 17) relates to a previously described example (e.g., one of the examples 15 to 16) or to any of the examples described herein, further comprising that each entry of the transition table defines one or more conditions to be met for affecting the state change and the corresponding change of the state of the hardware device.

Another example (e.g., example 18) relates to a previously described example (e.g., example 17) or to any of the examples described herein, further comprising that the one or more conditions are based on one or more variables, with each variable representing one of a register or memory cell, a bit field in a register or memory cell, a relation between two register or memory cells or between bit fields of two registers or memory cells, and a logical combination of two or more relations.

Another example (e.g., example 19) relates to a previously described example (e.g., example 18) or to any of the examples described herein, further comprising that a value of a variable is one of a hexadecimal value, an indicator representing a relation between two bit fields, registers or memory cells, and a binary value.

Another example (e.g., example 20) relates to a previously described example (e.g., one of the examples 18 to 19) or to any of the examples described herein, further comprising that a relation is one of equal, greater than or smaller than.

Another example (e.g., example 21) relates to a previously described example (e.g., one of the examples 18 to 20) or to any of the examples described herein, further comprising that wo entries of the transition table are determined to be equivalent if the one or more conditions and the corresponding change of the state of the hardware are equivalent.

Another example (e.g., example 22) relates to a previously described example (e.g., one of the examples 18 to 21) or to any of the examples described herein, further comprising that a condition defines either a value of a variable or that the variable is irrelevant for the entry, wherein two entries are determined to be equivalent if a first of the two entries comprises a condition that defines that a given variable is irrelevant and if a second of the two entries either comprises the condition that defines that the given variable is irrelevant or the second entry lacks a condition that is based on the given variable.

Another example (e.g., example 23) relates to a previously described example (e.g., one of the examples 15 to 22) or to any of the examples described herein, further comprising that the transition table is generated based on a plurality of hardware instructions defined in the specification of the hardware device, wherein the entries in the transition table are based on the plurality of hardware instructions.

Another example (e.g., example 24) relates to a previously described example (e.g., example 23) or to any of the examples described herein, further comprising that each hardware instruction is related to one or more entries in the transition table.

Another example (e.g., example 25) relates to a previously described example (e.g., one of the examples 15 to 24) or to any of the examples described herein, further comprising that the means is configured to determine classes of equivalent entries of the transition table, and to pick one entry of each class of equivalent entries for the plurality of test cases.

Another example (e.g., example 26) relates to a previously described example (e.g., example 25) or to any of the examples described herein, further comprising that the entry is picked randomly.

Another example (e.g., example 27) relates to a previously described example (e.g., one of the examples 25 to 26) or to any of the examples described herein, further comprising that the means is configured to, if an entry is picked for a first class of equivalent entries that is related to a hardware instruction that is further related to another entry that is picked for a second class of equivalent entries, pick an additional entry for the first class of equivalent entries.

Another example (e.g., example 28) relates to a previously described example (e.g., one of the examples 15 to 27) or to any of the examples described herein, further comprising that the hardware device is a central processing unit and the hardware instructions are central processing unit instructions.

An example (e.g., example 29) relates to a method for generating test cases for a verification of hardware instructions of a hardware device in a hypervisor, the method comprising generating (110) a transition table based on a specification of the hardware device, the transition table comprising a plurality of entries, with each entry representing a change of a state of the hardware device in response to an event. The method comprises determining (120) entries of the transition table that are equivalent. The method comprises generating (140) a plurality of test cases based on the entries of the transition table, wherein at least one entry of the transition table is omitted in the generation of the test cases due to being equivalent to another entry of the transition table.

Another example (e.g., example 30) relates to a previously described example (e.g., example 29) or to any of the examples described herein, further comprising that the event comprises one of an execution of a pre-defined instruction, an occurrence of an exception and an occurrence of an external interrupt.

Another example (e.g., example 31) relates to a previously described example (e.g., one of the examples 29 to 30) or to any of the examples described herein, further comprising that each entry of the transition table defines one or more conditions to be met for affecting the state change and the corresponding change of the state of the hardware device.

Another example (e.g., example 32) relates to a previously described example (e.g., example 31) or to any of the examples described herein, further comprising that the one or more conditions are based on one or more variables, with each variable representing one of a register or memory cell, a bit field in a register or memory cell, a relation between two register or memory cells or between bit fields of two registers or memory cells, and a logical combination of two or more relations.

Another example (e.g., example 33) relates to a previously described example (e.g., example 32) or to any of the examples described herein, further comprising that a value of a variable is one of a hexadecimal value, an indicator representing a relation between two bit fields, registers or memory cells, and a binary value.

Another example (e.g., example 34) relates to a previously described example (e.g., one of the examples 32 to 33) or to any of the examples described herein, further comprising that a relation is one of equal, greater than or smaller than.

Another example (e.g., example 35) relates to a previously described example (e.g., one of the examples 32 to 34) or to any of the examples described herein, further comprising that wo entries of the transition table are determined to be equivalent if the one or more conditions and the corresponding change of the state of the hardware are equivalent.

Another example (e.g., example 36) relates to a previously described example (e.g., one of the examples 32 to 35) or to any of the examples described herein, further comprising that a condition defines either a value of a variable or that the variable is irrelevant for the entry, wherein two entries are determined to be equivalent if a first of the two entries comprises a condition that defines that a given variable is irrelevant and if a second of the two entries either comprises the condition that defines that the given variable is irrelevant or the second entry lacks a condition that is based on the given variable.

Another example (e.g., example 37) relates to a previously described example (e.g., one of the examples 29 to 36) or to any of the examples described herein, further comprising that the transition table is generated based on a plurality of hardware instructions defined in the specification of the hardware device, wherein the entries in the transition table are based on the plurality of hardware instructions.

Another example (e.g., example 38) relates to a previously described example (e.g., example 37) or to any of the examples described herein, further comprising that each hardware instruction is related to one or more entries in the transition table.

Another example (e.g., example 39) relates to a previously described example (e.g., one of the examples 29 to 38) or to any of the examples described herein, further comprising that the method comprises determining (130) classes of equivalent entries of the transition table and picking (132) one entry of each class of equivalent entries for the plurality of test cases.

Another example (e.g., example 40) relates to a previously described example (e.g., example 39) or to any of the examples described herein, further comprising that the entry is picked randomly.

Another example (e.g., example 41) relates to a previously described example (e.g., one of the examples 39 to 40) or to any of the examples described herein, further comprising that the method comprises, if an entry is picked (132) for a first class of equivalent entries that is related to a hardware instruction that is further related to another entry that is picked for a second class of equivalent entries, picking (134) an additional entry for the first class of equivalent entries.

Another example (e.g., example 42) relates to a previously described example (e.g., one of the examples 29 to 41) or to any of the examples described herein, further comprising that the hardware device is a central processing unit and the hardware instructions are central processing unit instructions.

An example (e.g., example 43) relates to a machine-readable storage medium including program code, when executed, to cause a machine to perform the method of one of the examples 29 to 42.

An example (e.g., example 44) relates to a computer program having a program code for performing the method of one of the examples 29 to 42 when the computer program is executed on a computer, a processor, or a programmable hardware component.

An example (e.g., example 45) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for generating test cases for a verification of hardware instructions of a hardware device in a hypervisor, the apparatus comprising interface circuitry and processing circuitry to:
generate a transition table based on a specification of the hardware device, the transition table comprising a plurality of entries, with each entry representing a change of a state of the hardware device in response to an event;
determine entries of the transition table that are equivalent;
generate a plurality of test cases based on the entries of the transition table, wherein at least one entry of the transition table is omitted in the generation of the test cases due to being equivalent to another entry of the transition table.

2. The apparatus according to claim 1, wherein the event comprises one of an execution of a pre-defined instruction, an occurrence of an exception and an occurrence of an external interrupt.

3. The apparatus according to claim 1, wherein each entry of the transition table defines one or more conditions to be met for affecting the state change and the corresponding change of the state of the hardware device.

4. The apparatus according to claim 3, wherein the one or more conditions are based on one or more variables, with each variable representing one of a register or memory cell, a bit field in a register or memory cell, a relation between two register or memory cells or between bit fields of two registers or memory cells, and a logical combination of two or more relations.

5. The apparatus according to claim 4, wherein a value of a variable is one of a hexadecimal value, an indicator representing a relation between two bit fields, registers or memory cells, and a binary value.

6. The apparatus according to claim 4, wherein a relation is one of equal, greater than or smaller than.

7. The apparatus according to claim 4 wherein two entries of the transition table are determined to be equivalent if the one or more conditions and the corresponding change of the state of the hardware are equivalent.

8. The apparatus according to claim 4, wherein a condition defines either a value of a variable or that the variable is irrelevant for the entry, wherein two entries are determined to be equivalent if a first of the two entries comprises a condition that defines that a given variable is irrelevant and if a second of the two entries either comprises the condition that defines that the given variable is irrelevant or the second entry lacks a condition that is based on the given variable.

9. The apparatus according to claim 1, wherein the transition table is generated based on a plurality of hardware instructions defined in the specification of the hardware device, wherein the entries in the transition table are based on the plurality of hardware instructions.

10. The apparatus according to claim 9, wherein each hardware instruction is related to one or more entries in the transition table.

11. The apparatus according to claim 1, wherein the processing circuitry is configured to determine classes of equivalent entries of the transition table, and to pick one entry of each class of equivalent entries for the plurality of test cases.

12. The apparatus according to claim 11, wherein the entry is picked randomly.

13. The apparatus according to claim 11, wherein, the processing circuitry is configured to, if an entry is picked for a first class of equivalent entries that is related to a hardware instruction that is further related to another entry that is picked for a second class of equivalent entries, pick an additional entry for the first class of equivalent entries.

14. The apparatus according to claim 1, wherein the hardware device is a central processing unit and the hardware instructions are central processing unit instructions.

15-17. (canceled)

18. A method for generating test cases for a verification of hardware instructions of a hardware device in a hypervisor, the method comprising:
generating a transition table based on a specification of the hardware device, the transition table comprising a plurality of entries, with each entry representing a change of a state of the hardware device in response to an event;
determining entries of the transition table that are equivalent;
generating a plurality of test cases based on the entries of the transition table, wherein at least one entry of the transition table is omitted in the generation of the test cases due to being equivalent to another entry of the transition table.

19. The method according to claim 18, further comprising determining classes of equivalent entries of the transition table and picking one entry of each class of equivalent entries for the plurality of test cases.

20. The method according to claim 19, further comprising, if an entry is picked for a first class of equivalent entries that is related to a hardware instruction that is further related to another entry that is picked for a second class of equivalent entries, picking an additional entry for the first class of equivalent entries.

21. A machine-readable storage medium including program code, when executed, to cause a machine to perform the method of claim 18.

22. The method according to claim 18, wherein the entry is picked randomly.
